(19) United States
(12) Patent Application Publication
(10) Pub. No.: US 2005/0165977 A1
(43) Pub. Date: Jul. 28, 2005

(54) Printing device

(76) Inventor: George John Morawski, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/764,236

(22) Filed: Jan. 23, 2004

(51) Int. Cl. G06F 3/00

(52) U.S. Cl. 710/15

(57) ABSTRACT

A print job having a plurality of blocks of data is generated. At least one of the plurality of blocks has a header portion. A type of data of the at least one of the plurality of blocks of data is indicated in the header portion.

### BACKGROUND OF THE INVENTION

In one instance, in order to print a job, a host computer may communicate with a print controller in a printer. A print job is a command that includes information and data used to carry out a print command. A print job generally includes a header portion which is typically in a human readable text format such as ASCII format, and a data portion which is typically in a machine readable binary format. The header portion in current print jobs contains information specific to the print job.

Current print jobs can include more than one type of data. The type of data is referred to as a context. The data is placed in a data portion of a print job. The formats or contexts of this data are known generally as page description languages (“PDL”). PDL is a language for describing the layout and contents of a printed page. PDL is also a file format, close to a programming language, for describing the contents of a printed page in a higher level than the actual output bitmap. There are many different kinds of PDLs. A parser aboard a printer may have the capability to recognize many of the various PDLs in order to be backwards compatible and have the capability to receive and process various print jobs from various sources.

Current print jobs having several contexts are formed as a continuous string of data. Within the continuous strings of data, specific binary strings are used to indicate a change from one context to another in a print job. The parser associated with a printer recognizes the specific binary string and changes to the next context. For example, one certain binary string will indicate to a parser that the data that follows in the print job is in a particular printer control language, such as PCL5. Another binary string may indicate to the parser that the data that follows is in another particular printer control language, such as PCL6. Yet another binary string will indicate to the parser that the data that follows is in Postscript. Postscript, PCL5, and PCL6 are all object-oriented, meaning that they describe a page in terms of geometrical objects such as lines, arcs, and circles. Still other binary strings indicate that the data that follows is another PDL, such as HPGL or PGL, just to name a few. There can also be data in different formats embedded within a particular PDL. For example, a bit map can be embedded in a PCL6 file.

A portion of the binary string of data that matches or nearly matches a binary string can prematurely trigger the parser to move into a different context such as when the PDL is about to change. After moving into the different context, the parser hangs the print job because the data, as read by the parser, is in another context. A patchwork of various prohibited strings of binary that can not be used for data is then implemented. The patchwork of prohibited strings will continue to grow as PDLs are improved or more PDLs are added. The more extensive the patchwork of prohibited strings the more probable that printers will hang in the middle of print jobs.

### BRIEF DESCRIPTION OF THE DRAWINGS

FIG. 1 is a schematic diagram of an electronic device according to an embodiment of this invention.

FIG. 2 is a schematic diagram of a printer and a host computer connected by a channel, according to an embodiment of this invention.

FIG. 3A is a representation of a data structure, according to an embodiment of the invention.

FIG. 3B is a representation of a data structure, according to another embodiment of the invention.

FIG. 4 is a block diagram of a computer readable medium that includes an instruction set thereon, according to an embodiment of this invention.

### DETAILED DESCRIPTION

In the following description, the drawings illustrate specific embodiments of the invention sufficiently to enable those skilled in the art to practice it. Other embodiments may incorporate structural, logical, electrical, process, and other changes. Examples merely typify possible variations. Individual components and functions are optional, and the sequence of operations may vary. Portions and features of some embodiments may be included in or substituted for those of others. The scope of the invention encompasses the full ambit of the claims and all available equivalents. The following description is, therefore, not to be taken in a limited sense, and the scope of the embodiments of the present invention is defined by the appended claims.

The functions described herein are implemented in software in one embodiment, where the software comprises computer executable instructions stored on computer readable media such as memory or other type of storage devices. The term “computer readable media” is also used to represent carrier waves on which the software is transmitted. Further, such functions correspond to modules, which are software, hardware, firmware of any combination thereof. Multiple functions are performed in one or more modules as desired, and the embodiments described are merely examples.

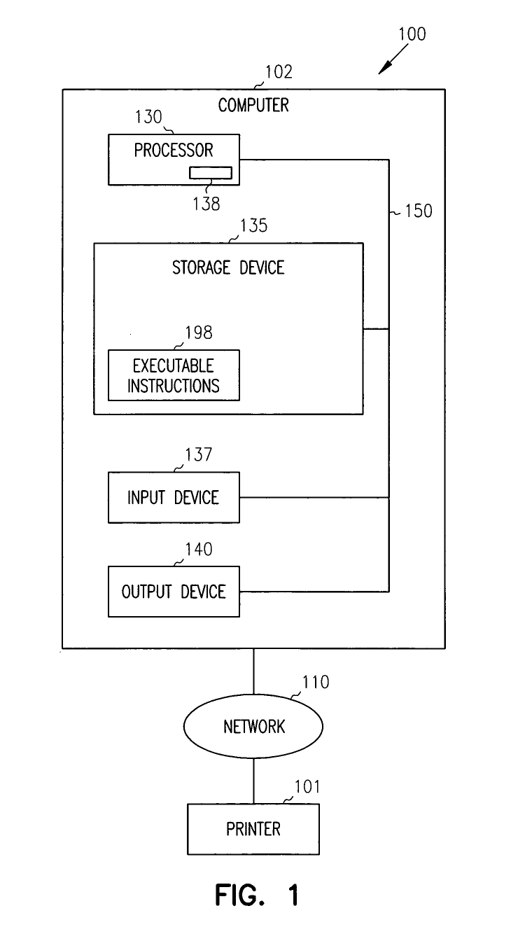

FIG. 1 is a schematic diagram of a system 100. The system 100 includes a computer 102 according to an embodiment of this invention. The computer 102 includes a processor 130, a storage device 135, a bus 150, an input device 137 and an output device 140. The system further includes a network 110 and a printer 101. The computer 102 is communicatively coupled to the printer 101 via the network 110. The storage device 135 includes executable instructions 198. The executable instructions 198 are stored within the storage device 135.

The processor 130 represents a central processing unit of any type of architecture, such as a CISC (Complex Instruction Set Computing), RISC (Reduced Instruction Set Computing), VLIW (Very Long Instruction Word), or hybrid architecture, although any appropriate processor may be used. The processor 130 executes instructions and includes that portion of the computer 102 that controls the operation of the computer 102. The processor 130 typically includes a control unit 138 that organizes data and organizes program storage in memory and transfers data and other information between the various parts of the computer 102. As shown, the control unit 138 is part of the processor 130. In other embodiments, the control unit 138 is separate from the processor 130 and interacts with the processor 130. The processor 130 receives input data from the input device 137 and the network 110, reads and stores code and data in the storage device 135, and presents data to an output device 140 and/or the network 110.

Although the computer 102 is shown to contain a single processor 130 and a single bus 150, the present invention applies equally to computers that may have multiple processors and multiple buses with some or all performing different functions in different ways.

The storage device 135 represents one or more mechanisms for storing data. For example, the storage device 135 may include read only memory (ROM), random access memory (RAM), magnetic disk storage media, optical storage media, flash memory devices, and/or other machine-readable media. In other embodiments, any appropriate type of storage device may be used. Although one storage device 135 is shown, multiple storage devices and multiple types of storage devices may be present. In various embodiments of the computer 102, the control unit 138 and a set of computer-readable instructions 198 in the control unit 138 are used to control various parts of the computer 102, and to deliver data and other information to various portions of the system 100. The set of computer-readable instructions may be stored in one storage device or in several different storage devices. Further, although the computer 102 contains the storage device 135, in some embodiments, the storage device may be distributed across other computers attached to the network 110.

The control unit 138 accesses a set of computer-readable instructions 198 capable of being executed on the processor 130 to carry out the functions of the present embodiment. The control unit 138 includes memory for storing all or at least a portion of the set of computer-readable instructions 198. In some embodiments, some or all of the functions of the computer 102 are carried out via hardware. In other embodiments, some or all of the functions of the computer 102 are carried out in software. In still other embodiments, some or all of the functions of the computer 102 are carried out in a combination of hardware and software, in lieu of a processor-based system.

The input device 137 may be a keyboard, mouse or other pointing device, trackball, touchpad, touchscreen, keypad, microphone, voice recognition device, or any other appropriate mechanism for the user to input data to the electronic device 100. Although one input device 137 is shown, in another embodiment any number (including none) and type of input devices may be present.

The output device 140 is that part of the computer 102 that communicates output to the user. The output device 140 may be a cathode-ray tube (CRT) based video display well known in the art of computer hardware. But, in other embodiments the output device 140 may be replaced with a liquid crystal display (LCD) based or gas, plasma-based, flat-panel display. In another embodiment, the output device 140 may be a speaker. In still other embodiments, any appropriate output device may be used. Although one output device 140 is shown, in other embodiments, any number (including none) of output devices of different types or of the same type may be present. In one embodiment, the output device is integral with the computer 102. In another embodiment, the output device is a separate, stand-alone device.

The bus 150 may represent one or more busses, e.g., PCI, ISA (Industry Standard Architecture), X-Bus, EISA (Extended Industry Standard Architecture), or any other appropriate bus and/or bridge (also called a bus controller).

The computer 102 can be any type of hardware having a processor 130 and a storage device 135 for storing a set of computer-readable instructions 198 executable by the computer 102. For example, the computer 102 can include a personal computer, a portable computer, a laptop computer, a notebook computer, a PDA (Personal Digital Assistant), a pocket computer, a cellular telephone, a pager, a mainframe computer or the like. All of the above are examples of other possible configurations of the computer 102. A computer 102 also may be within any other device, such as a printer that includes a processor, a storage device and computer-readable instructions stored within the storage device. The hardware and software depicted in FIG. 1 may vary for specific applications and may include more or fewer elements than those depicted. For example, other peripheral devices such as audio or chip programming devices, such as EPROM (Erasable Programmable Read-Only Memory) programming devices may be used in addition to or in place of the hardware already depicted.

The network 110 may be any suitable network and may support any appropriate protocol suitable for communication between the computer 102 and the network 110. In an embodiment, the network 110 may support wireless communications. In another embodiment, the network 110 may support hard-wired communications, such as a telephone line or cable. In another embodiment, the network 110 may support the Ethernet IEEE (Institute of Electrical and Electronics Engineers) 802.3x specification. In another embodiment, the network 110 may be the Internet and may support IP (Internet Protocol). In another embodiment, the network 110 may be a local area network (LAN) or a wide area network (WAN). In another embodiment, the network 110 may be an intranet. In another embodiment, the network 110 may be a GPRS (General Packet Radio Service) network. In another embodiment, the network 110 may be any appropriate cellular data network or cell-based radio network technology. In another embodiment, the network 110 may be a wireless network. In still another embodiment, the network 110 may be any suitable network or combination of networks. Although one network 110 is shown, in other embodiments any number of networks (of the same or different types) may be present.

Aspects of an embodiment pertain to specific apparatus and method elements implementable on a computer. In another embodiment, a program product for use with a computer 102 may be implemented. The programs defining the functions of this embodiment may be delivered to a computer 102 via a variety of signal-bearing media, which include, but are not limited to:
(1) Information permanently stored on a non-rewriteable storage medium, e.g., a read-only memory device attached to or within an electronic device, such as a CD-ROM readable by a CD-ROM drive;
(2) Alterable information stored on a rewriteable storage medium, e.g., a hard disk drive or diskette; or
(3) Information conveyed to an electronic device by a communications medium, such as through a computer or a telephone network, including wireless communications.

Such signal-bearing media, when carrying machine-readable instructions that direct the functions of computers, and devices that include computers represent embodiments of the present invention.

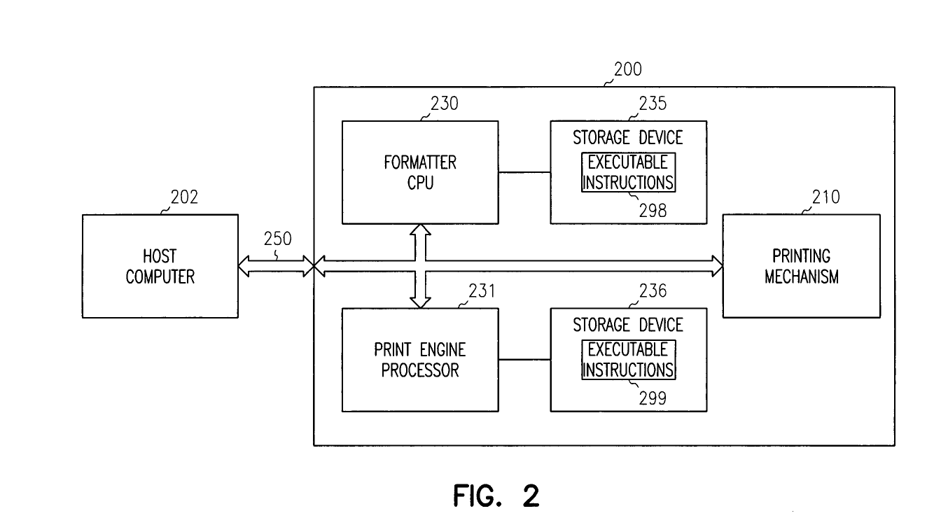

FIG. 2 is a schematic diagram of a printing apparatus 200 and a host computer 202 connected by a channel 250, according to an embodiment of this invention. The host computer 202 is similar to the computer 102 shown in FIG. 1. The channel 250 can be a direct communicative coupling between the host computer 202 and the printing apparatus 200 or the channel 250 can be a communicative coupling through a network 110 (shown in FIG. 1). The printing apparatus 200 can be either dedicated solely to the host computer 202 or can be a shared resource which receives print commands or print jobs from a number of different host computers.

A print command or a print job is sent over the channel 250 to the printing apparatus 200. The printing apparatus 200 includes a printing mechanism 210 as well as a first processor or formatter CPU 230 and a second processor or print engine processor 231. Attached to the first processor or formatter CPU 230 is a storage device 235. An executable instruction set 298 is stored on storage device 235. The second processor 231 is a print engine processor. Attached to the print engine processor or second processor 231 is a storage device 236. The storage device 236 includes a set of executable instructions 299 which are used to determine various parameters associated with printing a print job. The first processor 230 and the second processor 231 are shown as separate processors in FIG. 2. It is contemplated that one processor could be used to provide both functions, in some embodiments of the invention.

The print engine processor or second processor 231 is the main component of the printing apparatus 200 that actually performs the printing. The print engine processor or second processor 231 determines how fast and at what resolution the printing mechanism 210 will print. In addition, the print engine processor or second processor 231 controls many of the aspects of the printing apparatus 200.

The formatter CPU or first processor 230 decodes the print job and assembles the commands which are then sent to the print engine processor or second processor 231. The storage device 235 and the executable instructions 298 within the storage device are used by the formatter processor or first processor 230 to decode the print jobs passed from the host computer 202 to the printing apparatus 200. The executable instruction set 298 includes a listing of instructions to properly decode the print command. In some embodiments the executable instruction set 298 also includes instructions for detecting errors and correcting errors within portions of the print job.

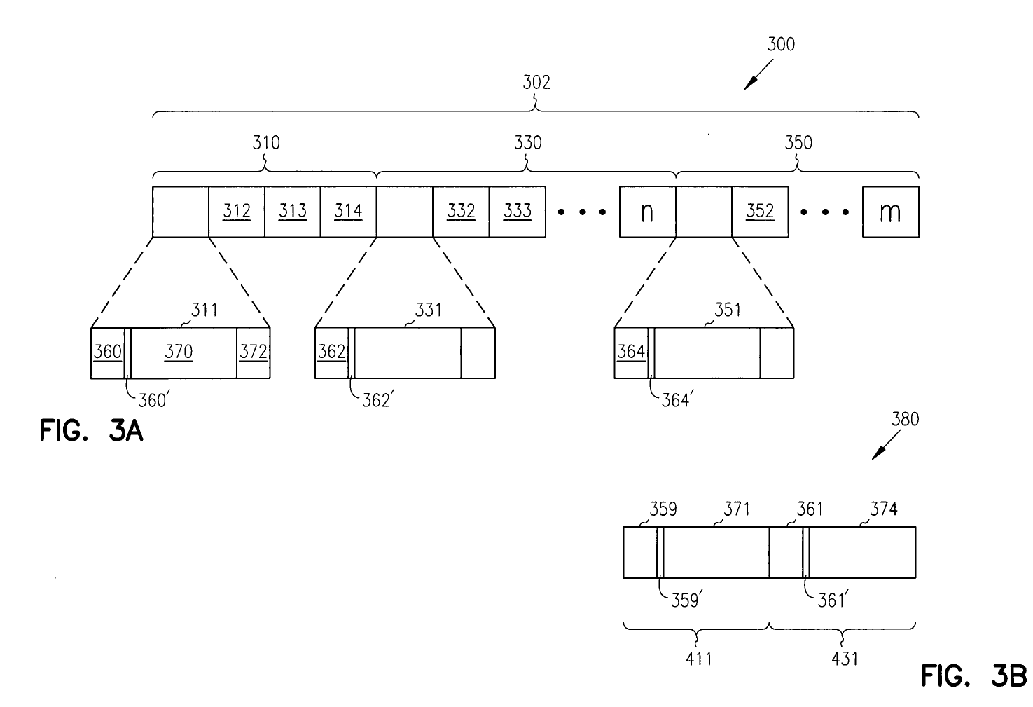

FIG. 3A is a representation of a data structure 300 according to an embodiment of this invention. The print job depicted by reference numeral 302 includes a plurality of blocks 311, 312, 313, 314, 331, 332, 333 . . . n, 351, 352 . . . m. The blocks are grouped or placed into groups 310, 330, 350. Within each group 310, 330, 350 the type of data within each of the groups is the same. For example, the blocks in group 310 which include blocks 311, 312, 313, 314 will carry the same type of data in each block. The blocks in group 330, namely blocks 331, 332, 333 . . . n, all carry the same type of data. The blocks in group 350, namely blocks 351, 352 . . . m all carry the same type of data. The type of data carried by the blocks in group 310 may be different than the type of data carried by the blocks in group 330 or the data carried by the blocks in group 350. It should also be noted that in any print job there may be as few as two groups of blocks 310, 330 or many more than the three groups of blocks 310, 330, 350 shown in FIG. 3A. The length of each block can be fixed or variable.

Generating a block including a type of data and a header identifying the data in the block is alternately referred to as data framing. The discussion will now further detail data framing on the groups of blocks 310, 330, and 350. In some embodiments, the different types of data include information that is encoded using a different coding language. In one embodiment, the blocks in group 310 include printer job language (“PJL”) and the blocks in group 330 include a page description language (“PDL”) such as program control language 6 (“PCL6”), program control language 5 (“PCL5”) or postscript. Other data that can be carried in a block of data include a graphic compressed mode, or bit level encoding, or any other type of data to be used in formulating a print command. The third group of blocks 350 includes another type of data, such as a second PDL or data related to a bit map. The data within a group of blocks includes scanned images as well as other types of data.

Each of the blocks is similarly structured as shown by the breakout of blocks 311 and 331. Since the blocks are similarly structured, only one of the blocks will be discussed for the sake of brevity. Block 311 includes a header portion 360, a data portion 370, and an integrity portion 372. The header 360 includes an indicator 360′ of the type of data in the data portion 370. In other words, the type of data within the data portion 370 of each of the blocks 311, 312, 313, 314, 331, 332, 333 . . . n, 351, 352 . . . m can be identified by reading the header portion 360.

The header 360, in some embodiments, may also include the length of the data portion or the length of the block. In some embodiments, the length of the block or the length of the data portion 370 of the block may be variable, while in other embodiments, the length of the block or the length of the data portion 370 of the block may be fixed. In some embodiments, there is one block associated with a first group of data and a second block associated with a second group of data.

In some embodiments at least one of the blocks includes a data integrity portion 372. The data integrity portion 372 can include a set of data or code used to detect an error such as check sum data that assures that the data within the data portion 370 of the block 311 was not incorrectly read by the first processor or formatter CPU 230. In other embodiments, the integrity portion 372 includes an error detection portion and an error correction portion so that if the data within the data portion 370 is not read correctly, an error is detected and an error is corrected within the data before assembling the data from within a group of blocks to form print commands for the print engine or second processor 231 of the printing apparatus 200.

As a result, the first processor or formatter CPU 230 of the printing apparatus 200 that functions as a decoder and parser, does not have to rely on a reading a specific string of binary code to determine a change in the type of data that follows the specific string of binary code. The first processor or formatter CPU 230 reads the header information to determine the type of information within the block.

The printing apparatus 200 includes the processor, 230, 231, the storage device 235, 236, and software operable on the processor 230, 231 to: identify a plurality of first type of blocks 310, extract data from the plurality of first type or group of blocks 310, and identify a plurality of second type of blocks 330, extract data from the plurality of second type or group of blocks 330, and assemble the data from the first and second block types 310, 330 into print commands related to placing information on one or more pages. The first type of block 310 includes a first type of data portion and a second type of block 330 includes a second type of data portion. The software identifies a first type of blocks 310 by reading a header 360 in each of the first type of blocks 310. The header 360 of the block includes information for identifying the first type of blocks 310. The software identifies a second type of blocks 330 by reading a header 362 in each of the second type of blocks 330. For example, a header 362 includes information for identifying the second type of block 331. Block 311 is one of the group of blocks 330. Extracting the data of one of the first type of blocks 310 or the second type of blocks 330 includes extracting PDL. In another embodiment, extracting the data of the other of the first type of blocks 310 or the second type of blocks 330 includes extracting PJL. The software is also operable on the processor 230, 231 to check the integrity of the data within the first type of blocks 310 and the second type of blocks 330. The software is also operable on the processor to check the integrity of the data within the blocks.

Turning now to FIGS. 2 and 3A, a print job data communication system includes the host computer 202, the printing apparatus 200, a data structure 300 for communicating a print job, the first processor 230, the set of executable instructions 298, and the channel 250. The data structure 300 is contained in a memory 235, 236 and includes the first block 311 and the second block 331. The first block includes the header 360 including the first identifier 360′ for a first language, and the first portion of data 370 in a first language. The second block 331 includes the header 362 including a second identifier 362′ for a second language, and the second portion of data in the second language. The processor 230 uses a program or set of executable instructions 298 to parse the first portion of data 370 from the first block 311 and to parse the second portion of data from the second block 331. The host computer 202 formulates the print job and uses the channel 250 to transmit the print job to the first processor 230 of the printing apparatus 200. In some embodiments, the print job communications system further includes a third block 351 having a header including a third identifier for a third language, and a portion of data in the third language.

FIG. 3B is a representation of a data structure according to another embodiment of the invention. In this other embodiment, the data structure 380 for a print job includes a first block 411 having a header 359, and a data portion 371. The header of the first block 411 includes an identifier 359′ of a type of data in the data portion 371 of the first block 411. The data structure 380 also includes a second block 431 having a header 361, and a data portion 374. The header 361 of the second block includes an identifier 361′ of a type of data in the data portion 374 of the second block 431. In one embodiment of the invention, the type of data in the first block 411 and the type of data in the second block 431 differ. In another embodiment, the data in the first and second block are the same. The length of each block can be fixed or variable.

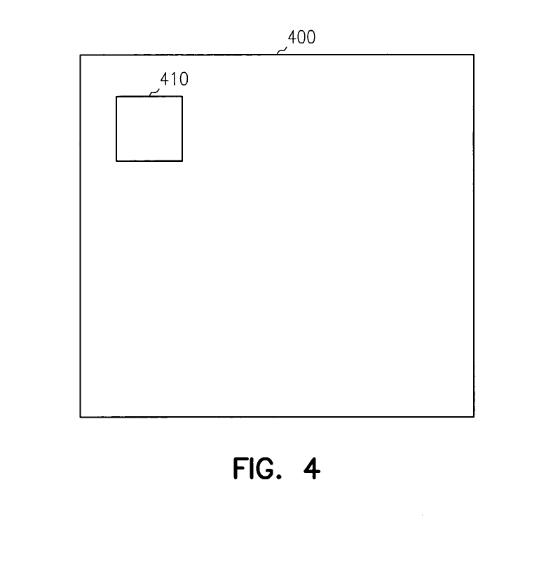

FIG. 4 is a block diagram of a computer-readable medium 400 that includes an instruction set 410, thereon. The instruction set 410 can be any set of instructions including a computer program. The computer-readable medium can be any computer-readable medium including a storage device or a signal-bearing medium. A computer-usable storage medium having a computer program thereon causes a suitably configured computer 102 or information-handling system to form or generate a print job by performing the following steps when such program is executed on the system: generating a print job having a plurality of blocks 311, 312, 313, 314, 331, 332, 333 . . . n, 351, 352 . . . m and indicating a type of data in a header portion 360 at least one of the plurality of blocks 311, 312, 313, 314, 331, 332, 333 . . . n, 351, 352 . . . m. In some embodiments, the method also includes indicating a length of the data portion of the block in the header portion 360 in each of the plurality of blocks 311, 312, 313, 314, 331, 332, 333 . . . n, 351, 352 . . . m. The data integrity portion 372 detects an error in a data portion 370 of the block. In one embodiment the portion 372 the data integrity portion includes a code added at the end of the block 311, 312, 313, 314, 331, 332, 333 . . . n, 351, 352 . . . m. In another embodiment, the data integrity portion 372 includes a code that detects and corrects an error in a data portion 370 of the block, and in one embodiment the code is added at the end of the block. Once the print job 302 is formed, it is sent over the channel 250 to the printing apparatus 200.

A computer-readable medium or signal-bearing medium 400 also causes a suitably configured computer 102 or processor 230, 231 in a printing apparatus 200 to identify a plurality of first type of blocks 310, extract data from the plurality of first type of blocks 310, identify a plurality of second type of blocks 330, extract data from the plurality of second type of blocks 330, and assemble the data from the first and second block types 310, 330 into print commands related to placing information on one or more pages. In some embodiments, the computer usable storage device or signal-bearing medium uses a set of instructions 410 called software. Again, there is a header associated with each block in the group of blocks. Each header is read by the software to identify the type of data in the data portion of the block. Extracting the data of one of the first type of blocks 310 or the second type of blocks 330 includes extracting PDL. In another embodiment, extracting the data of the other of the first type of blocks 310 or the second type of blocks 330 includes extracting PJL. The software is also operable on the processor 230, 231 to check the integrity of the data within the first type of blocks 310 and the second type of blocks 330. The software is also operable on the processor to check the integrity of the data within the blocks.

One embodiment of the invention includes a signal-bearing medium encoded with a data structure accessed by a program that is to be executed by a processor. In this embodiment, the data structure includes a print job having a plurality of blocks with headers that identify the type of data with the block. Such signal-bearing media, when carrying machine-readable instructions that direct the functions of a computer 102 or the printing apparatus 200, represents an embodiment of the present invention.

In operation, the host computer 202 includes a printer driver, which is the software including the computer-readable set of instructions 410 to properly form print commands for a particular printing apparatus 200. The host computer 202 also includes a processor 130 and controller and executable instructions 198 for generating or forming a print command into a print job 302 having a data structure 300. The host computer 202 forms a print job 302 by implementing a method. The method of forming a print job includes generating a print job having a plurality of blocks 311, 312, 313, 314, 331, 332, 333 . . . n, 351, 352 . . . m. The method also includes indicating the type of data in the header portion 360, 362 in each at least two of the plurality of blocks 311, 312, 313, 314, 331, 332, 333 . . . n, 351, 352 . . . m. In some embodiments of the invention, the method includes indicating a type of data in a first block using a first header and indicating a different type of data in a second block using a second header.

In some embodiments the length of the blocks of blocks 311, 312, 313, 314, 331, 332, 333 . . . n, 351, 352 . . . m is fixed. When the length of the block is fixed, the indicator in the header may not indicate a block length. In other embodiments, the method also includes indicating a length of the block in its header portion 360 for each of the blocks 311, 312, 313, 314, 331, 332, 333 . . . n, 351, 352 . . . m. In some embodiments, a length of a data portion 370 in each of the plurality of blocks is indicated in its header portion 360. The data integrity portion 372 includes a code to detect an error in a data portion 370 of the block. In some embodiments, the data integrity portion is added at the end of the block 311, 312, 313, 314, 331, 332, 333 . . . n, 351, 352 . . . m. In another embodiment, the code or data integrity portion 372 detects and corrects an error in a data portion of the block. In still other embodiments, a code or data integrity portion 372 is not provided for one or more of the blocks, as shown in FIG. 3B. In some embodiments, a code or data integrity portion 372 is not provided for any of the blocks. Once the print job 302 is formed, it is sent over the channel 250 to the printing apparatus 202.

Although specific embodiments have been illustrated and described herein, those of ordinary skill in the art will appreciate that any arrangement calculated to achieve the same purpose can be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

1. A method comprising:
generating a print job having a plurality of blocks of data at least two of the plurality of blocks of data including a different type of data; and
indicating a type of data in a header portion in at least one of the plurality of blocks of data.

2. The method of claim 1 further comprising indicating a length of the block in the header portion.

3. The method of claim 1 further comprising indicating a length of a data portion in the header portion.

4. The method of claim 1 further comprising adding a data integrity portion to detect an error in a data portion of the block.

5. The method of claim 1 further comprising adding a data integrity portion to detect an error and to correct an error in a data portion of the block.

6. The method of claim 1 wherein generating a print job includes encoding program control language.

7. A print job data communication system comprising:
a data structure communicating a print job, the structure contained in a memory and comprising a plurality of blocks,
a first block including:
a header including a first identifier for a first language;
a first portion of data in the first language; and
a second block including:
a header including a second identifier for a second language; and
a second portion of data in the second language; and
a processor including a program parsing the first portion of data from the first block and the second portion of data from the second block.

8. The print job data communication system of claim 7 further comprising a third block including:
a header including a third identifier for a third language; and
a third portion of data in the third language.

9. The print job data communication system of claim 7 wherein one of the first language and the second language is a page description language.

10. The print job data communication system of claim 9 wherein the other of the first language and the second language is a printer job language.

11. The print job data communication system of claim 7 wherein the first data portion and the second data portion are assembled to form at least one print command controlling a printer.

12. The print job data communication system of claim 7 wherein the first data portion and the second data portion are assembled to form a print command controlling placements of objects on a printer page.

13. The print job data communication system of claim 7 wherein the first block and the second block each have a data integrity portion.

14. The print job data communication system of claim 13 wherein the data integrity portion of each block is a check sum.

15. The print job data communication system of claim 13 wherein the data integrity portion of each block includes an error detection portion.

16. The print job data communication system of claim 15 wherein the data integrity portion of each block includes an error correction portion.

17. A printing apparatus comprising:
a processor;
a storage device; and
software, embodied in the storage device, operable on the processor to:
identify a first group of blocks in a print job;
extract data from the first group of blocks; and
identify a second group of blocks in the print job;
extract data from the second group of blocks; and
assemble the data from the first and second groups into print commands.

18. The printing apparatus of claim 17 wherein the software identifies a first block type by reading a header in at least one of the first group of blocks, the header including information identifying the first group of blocks.

19. The printing apparatus of claim 18 wherein the software identifies the second block type by reading a header in at least one of the second group of blocks, the header including information for identifying the second group of blocks.

20. The printing apparatus of claim 17 wherein extracting the data of one of the first group of blocks and the second group of blocks includes extracting page definition language.

21. The printing apparatus of claim 17 wherein extracting the data of the one of the first group of blocks and the second group of blocks includes extracting printer job language.

22. The printing apparatus of claim 17 wherein extracting the data of the one of the first group of blocks and the second group of blocks includes extracting a graphic data compression mode.

23. The printing apparatus of claim 17 wherein extracting the data of the one of the first group of blocks and the second group of blocks includes extracting bit level encoding.

24. The printing apparatus of claim 17 wherein the software operable on the processor further operates on the first group of blocks and the second group of blocks to check data integrity of blocks within the groups.

25. A data structure, embodied in a computer-readable medium, for a print job comprising:
a first block including:
a header; and
a data portion, the header of the first block including an identifier of a type of data in the first block; and
a second block including:
a header;
a data portion, the header of the second block including an identifier of a type of data in the second block.

26. The data structure of claim 25 wherein the first block further comprises a data integrity portion.

27. The data structure of claim 25 wherein the second block further comprises a data integrity portion.

28. The data structure of claim 25 wherein the type of data in the first block and the type of data in the second block are the same.

29. The data structure of claim 28 further comprising a third block further comprising:
a header; and
a data portion, the header of the third block including an identifier of a type of data of the third block.

30. The data structure of claim 29 wherein the third block further comprises a data integrity portion.

31. The data structure of claim 29 wherein the type of data in the third block is different than the type of data in the first block and the second block.

32. The data structure of claim 28 wherein the data portion of the first type of block and the data portion of the second type of block has a fixed length.

33. The data structure of claim 28 wherein the data portion of the first type of block and the data portion of the second type of block has a variable length.

34. The data structure of claim 33 wherein the identifier portion of at least one of the first type of block or the second type indicates the length of the block.

35. The data structure of claim 25 wherein the type of data in the first block is different than the type of data in the second block.

36. A method of reading a print job comprising:
reading an indicator in a first header portion of a first block of the print job of a first encoding type; and
decoding the information in the first block using a decoder for the first encoding type.

37. The method of claim 36 further comprising reading an indicator in a second header portion of a second block of information in the print job of a second encoding type.

38. The method of claim 37 further comprising decoding the information in the second block using a decoder for the second encoding type.

39. The method of claim 36 further comprising printing the print job that includes decoded information from the first block.

40. The method of claim 38 further comprising printing the print job that includes decoded information from the first block and decoded information from the second block.

41. A printing device comprising:
means for reading an indicator in a first header portion of a first block of the print job of a first encoding type; and
means for decoding information from a second portion of the first block using the first encoding type.

42. The printing device of claim 41 further comprising:
means for reading an indicator in a first portion of a second block of the print job of a second encoding type; and
means for decoding information from a second portion of the second block using the second encoding type.
